(19) United States
(12) Patent Application Publication
(10) Pub. No.: US 2008/0029395 A1
(43) Pub. Date: Feb. 7, 2008

(54) Multi-functional filtration and ultra-pure water generator

(75) Inventor: Qinbai Fan, Chicago, IL (US)

Correspondence Address: MORRISON & FOERSTER LLP, 755 PAGE MILL RD, PALO ALTO, CA, 94304-1018, US

(73) Assignee: GAS TECHNOLOGY INSTITUTE, Des Plaines, IL (US)

(21) Appl. No.: 11/515,544

(22) Filed: Sep. 5, 2006

Related U.S. Application Data
(63) Continuation-in-part of application No. 11/497,092, filed on Aug. 1, 2006.

(51) Int. Cl. B01D 61/42; C25C 7/02

(52) U.S. Cl. 204/627; 204/280

(57) ABSTRACT

A water purification system having a porous anode electrode (20) and a porous cathode electrode (21), each of which is made of graphite, at least one metal oxide, and an ion-exchange, cross-linked, polarizable polymer. Disposed between the electrodes is an electrically non-conductive, fluid permeable separator element (22), whereby wastewater is able to flow from one electrode to the other electrode. The electrodes and separator may be disposed within a housing (23) having a wastewater inlet opening (24), and exhaust waste outlet opening (26) and a purified water outlet opening (25). In this way, components of the system are easily replaced should the need arise.

### BACKGROUND OF THE INVENTION

1. Field of the Invention

This invention relates to an apparatus for water purification. More particularly, this invention relates to a multi-functional apparatus for water purification having the functionality of ion-exchange, carbon adsorption, capacitive deionization and microfiltration. The apparatus is capable of removing ionized and non-ionized organic compounds, inorganic ions, particulates and bacteria from wastewater streams in a single unit to produce potable water. In particular, porous carbon-based plates function as impurities filters to remove ash, sand and high molecular species, as electrodes to concentrate and remove ionic species, and as adsorbents to remove organic materials and bacteria from the wastewater stream.

2. Description of Related Art

Known water purification methods include distillation, ion-exchange, carbon adsorption, filtration, ultrafiltration, reverse osmosis, electrodeionization, capacitive deionization, ultraviolet radiation and combinations thereof. However, each of these methods has shortcomings. Distillation cannot remove some volatile organics and it consumes large amounts of energy. In the ion-exchange process, water is percolated through bead-like spherical resin materials. However, the resin materials need to be regenerated and changed frequently. In addition, this method does not effectively remove particles, pyrogens, or bacteria. The carbon adsorption process can remove dissolved organics and chlorine with long life and high capacity; however, fine carbon particles are generated during the process due to corrosion. Micropore membrane filtration, a high cost process, removes all particles and microorganisms greater than the pore size of the membrane; however, it cannot remove dissolved inorganics, pyrogens or colloids. The ultrafilter is a tough, thin, selectively permeable membrane that retains most macromolecules above a certain size, including colloids, microorganisms, and pyrogens; however, it will not remove dissolved organics. Reverse osmosis is the most economical method for removing 90 to 99% of all contaminants. Reverse osmosis membranes are capable of rejecting all particles, bacteria, and organics; however, the flow rate or productivity is low. Electrodeionization, which is the subject matter of U.S. Pat. No. 6,824,662 B2 to Liang et al., is a combination of electrodialysis and ion-exchange, resulting in a process which effectively deionizes water while the ion-exchange resins are continuously regenerated by the electric current; however, this method requires pre-purification to remove powders and ash materials. Ultraviolet radiation cannot remove ionized inorganics.

FIG. 1 is a diagram showing a capacitive deionization process with carbon aerogel electrodes. In this process, salt water is introduced into the cell, the negative electrode (anode) 11 adsorbs positive ions 13 and the positive electrode (cathode) 12 adsorbs negative ions 14. When the cell is charged, pure water is obtained, and when the cell is discharged, concentrated salt water is removed. To achieve this result, pulsed electrical power at voltages from 1.2V to 0V is used for different time periods depending on the concentration of the salt water and the activity of the activated carbon. The more accessible surface area the electrode has, the more ions that can be stored. The main problem with this method is that the electrosorption capacity (salt removal) decreases with cycle life. Most of the capacity loss can be recovered by periodic reversing of the electrode polarization. However, the interface between the active carbon and the aerogel diminishes, reducing the actual electrode active area. That is, the carbon particles will no longer contact each other and, ultimately, will leach out. In addition, capacitive deionization requires aggressive pre-filtration and cannot remove non-ionic species.

An electrically regenerable electrochemical cell for capacitive deionization and electrochemical purification and regeneration of electrodes is taught by U.S. Pat. No. 6,309,532 B1 to Tran et al. The cell includes two end plates, one at each end of the cell, and a plurality of generally identical double-sided intermediate electrodes that are equidistally separated from each other between the two end plates. The electrodes comprise a Ti substrate coated with carbon gel (carbon aerogel). As the electrolyte enters the cell, it flows through a continuous serpentine channel formed by the electrodes, substantially parallel to the electrodes. By polarizing the cell, ions are removed from the electrolyte and are held in electric double layers formed at the carbon aerogel surfaces of the electrodes. The cell is regenerated electrically to desorb the previously removed ions. However, by virtue of the serpentine flow arrangement between the electrode plates, the useful area for the electrodes is limited to the electrode surface.

### SUMMARY OF THE INVENTION

It is one object of this invention to provide a method and apparatus for wastewater purification which addresses the shortcomings of the known methods and systems for wastewater purification.

It is one object of this invention to provide an apparatus for wastewater purification which removes ionized and non-ionized organic materials, inorganic ions, particulates and bacteria in a single unit process.

These and other objects of this invention are addressed in one aspect by an apparatus for water purification comprising a multi-functional, porous, carbon-based composite electrode comprising an ion-exchange resin as a binder, carbon black and/or graphite as active adsorbents, and metal oxides as adsorbent promoters. The porous carbon-based plates may be molded by mixing metal oxides, carbon and/or graphite powders, phenolic resin and a bubbling agent, such as ammonium bicarbonate. The resins are cross-linked for stability and the porosity of the resulting electrode plate is more than 50% by volume.

In another aspect, electrodes for use in water purification are provided, which electrodes function as electrical field suppliers, ion-exchange resin holders, and colloid powders filters. In operation, the positive electrode absorbs negative ions while the negative electrode adsorbs positive ions.

In another aspect, an apparatus for water purification is provided comprising a porous anode electrode, a porous cathode electrode, and an electrically non-conductive, fluid permeable separator element disposed between the anode electrode and the cathode electrode. Each of the electrodes comprises graphite, at least one metal oxide, and an ion-exchange, cross-linked, polarizable polymer. The electrodes and separator element are preferably disposed in an electrically non-conductive housing having a wastewater inlet opening and a purified water outlet opening and may be used in a single cell configuration or in a series configuration with additional cell units. The apparatus of this invention acts as a filter, organic and bacteria adsorbent and also functions as a desalination system. The apparatus may also be used to concentrate soluble salts from a dilute aqueous solution.

### BRIEF DESCRIPTION OF THE DRAWINGS

These and other objects and features of this invention will be better understood from the following detailed description taken in conjunction with the drawings, wherein:

FIG. 1 is a diagram depicting a conventional capacitive deionization method;

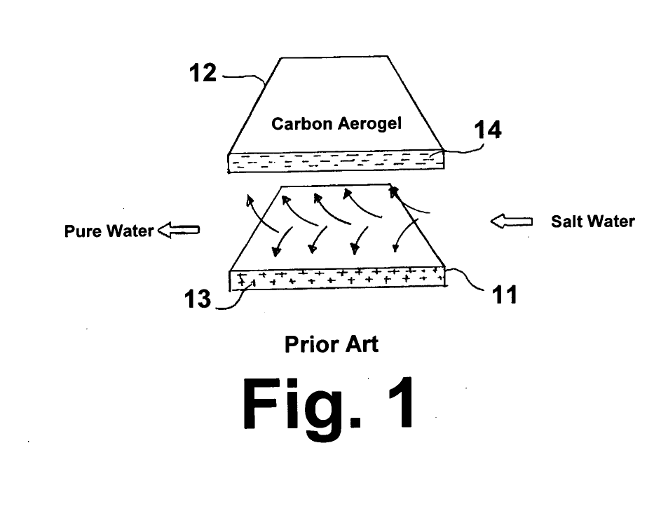

FIG. 2 is a diagram showing a single cell compartment for wastewater treatment in accordance with one embodiment of this invention;

FIG. 3 is a diagram showing a multi-cell compartment for wastewater treatment in accordance with one embodiment of this invention; and

FIG. 4 is a schematic diagram showing a two-stage water purification system in accordance with one embodiment of this invention.

### DETAILED DESCRIPTION OF THE PRESENTLY PREFERRED EMBODIMENTS

The invention disclosed and claimed herein is a water purification system which is capable of purifying most water streams requiring purification including industrial wastewater, gas and oil field wastewater, and coal mine wastewater and is well-suited for desalination of salt water. The system incorporates electrochemical deionization, microfiltration, and carbon adsorption features to remove organic materials, inorganic materials, bacteria and solid particles. The system is compact, energy efficient, and low cost.

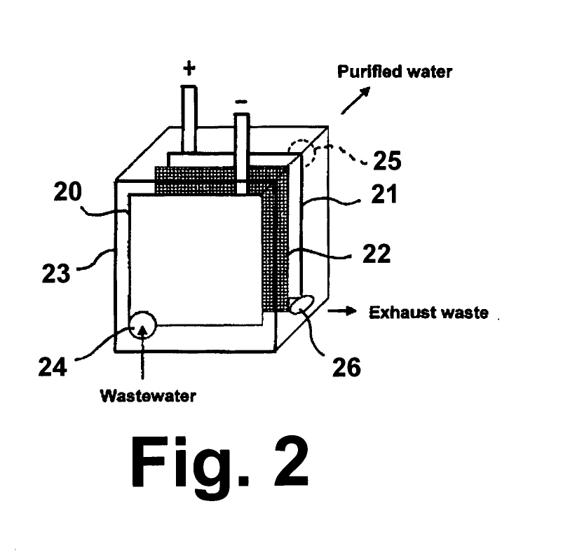

A water purification system in a single cell arrangement in accordance with one embodiment of this invention is shown in FIG. 2. The system comprises a porous anode electrode 20, a porous cathode electrode 21 and an electrically non-conductive, fluid permeable separator element 22 disposed between the anode electrode and the cathode electrode to prevent shorting. Fluid permeable separator element 22 in accordance with one embodiment of this invention is a perforated separator, such as perforated polyethylene, having an open area of at least about 60% enabling flow through of the wastewater. In accordance with one embodiment of this invention, the electrodes and the separator element are disposed within an electrically non-conductive, e.g. plastic, housing 23 which is provided with a wastewater inlet opening 24 for introducing the wastewater stream into the cell for processing, an exhaust waste outlet opening 26 through which solid materials separated out of the wastewater stream may be removed, and a purified water outlet opening 25 through which purified water may be removed. Thus, in the embodiment shown in FIG. 2, the wastewater is introduced into the housing through wastewater inlet opening 24 disposed near the bottom of housing 23 enabling particles and other solid matter in the wastewater filtered out by anode electrode 20 to fall to the bottom of the housing for removal through exhaust waste outlet opening 26. One of the benefits of this arrangement is the easy removal of the electrodes for replacement should the need arise.

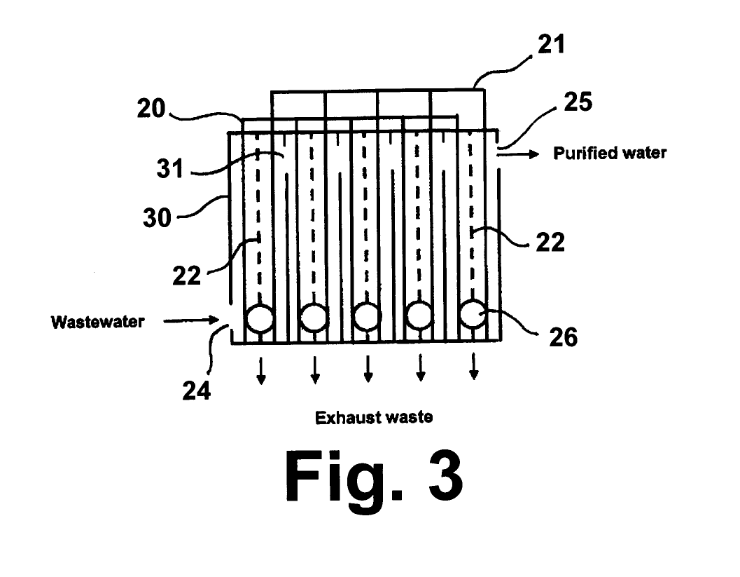

FIG. 3 is a schematic diagram of a water purification system in accordance with one embodiment of this invention comprising a plurality of cell units disposed within a housing 30 and arranged for sequential flow of the wastewater through the cells. That is, wastewater is introduced through wastewater inlet opening 24 disposed near the bottom of housing 40 into the first cell unit and rises within the cell unit. Solid materials within the wastewater fall to the bottom of the housing for removal through exhaust waste outlet opening 26. Upon rising to the top of the first cell unit, the wastewater, which is now substantially devoid of solid materials passes through intercell fluid opening 31 into the next cell unit for further treatment. The wastewater, which becomes more purified as it passes through each cell unit, is ultimately passed through purified water outlet opening 25 as substantially pure water.

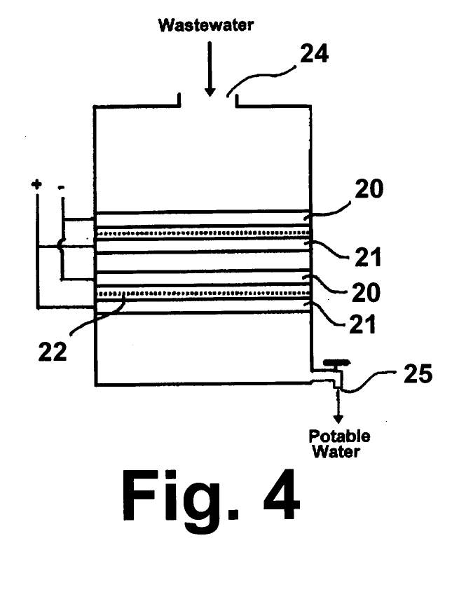

FIG. 4 shows a water purification system in accordance with yet another embodiment of this invention having two stages for producing potable water. In this embodiment, wastewater is introduced through wastewater inlet opening 24 at the top of the housing and filters through the two stages of cell units, becoming potable water in the process.

The electrodes, which provide particle filtration, ionic species concentration and removal, and organic material and bacteria removal, are carbon-based porous structures. In accordance with the embodiments shown in the drawings, the electrodes are porous planar structures, i.e. plates, and the separator element is a perforated plate. However, any other configurations of electrodes and separator elements which provides the desired relationship between the electrodes and the separator element, such as tubular or rolled structures, may also be employed, and it is to be understood that such configurations are also considered to be within the scope of the invention claimed herein.

There are three basic requirements for an electrode for the water purification system of this invention—porosity, electrical conductivity, and mechanical strength. Accordingly, the electrodes are carbon-based porous structures comprising graphite for conductivity, at least one metal oxide, for increasing water adsorption by the electrode, and an ion-exchange, cross-linked, polarizable polymer for binding the components of the electrode together. In accordance with one embodiment of this invention, electrical conductivity of the electrode may be enhanced by the addition of carbon black.

Exfoliated graphite is the product of very rapid heating (or flash heating) of graphite intercalation compounds, such as graphite hydrogen sulfate, of relatively large particle diameter (flakes). The vaporizing intercalated substances force the graphite layers apart resulting in an accordion-like shape with an apparent volume typically hundreds of times that of the original graphite flakes. In accordance with one preferred embodiment of this invention, the graphite employed in the electrodes of this invention is exfoliated graphite. In accordance with one preferred embodiment of this invention, the exfoliated graphite is in the form of particles less than about 50μ in size.

In addition to graphite and at least one metal oxide, the electrodes of this invention comprise at least one ion-exchange component, which, in addition to providing ion-exchange, may also be used to bind the components of the electrodes into a cohesive structure. In accordance with one embodiment of this invention, the ion-exchange component is a cross-linked, polarizable polymer. Cross-linking of the polarizable polymer is required to avoid dissolution of the polymer in the wastewater being treated. Suitable ion-exchange, cross-linked, polarizable polymers may be selected from the group consisting of polyurethane, polyacrylic acid, sulfonated polystyrene, poly(vinyl alcohol) and combinations thereof. Suitable agents for cross-linking of the polarizable polymers may be selected from the group consisting of glyoxal, aldehydes, such as formaldehyde and glutaraldehyde, methylene amine, and combinations thereof.

The electrodes of this invention are necessarily hydrophilic and, as previously indicated, at least one metal oxide is employed in the electrode for the purpose of increasing water adsorption. Any metal oxide that is stable in water may be utilized. In accordance with one preferred embodiment, the at least one metal oxide is selected from the group consisting of TiO₂, Al₂O₃ and mixtures thereof.

It will be appreciated that, depending upon the composition of the wastewater being treated, impurities such as oily tars and high organic species may collect on the electrode. Such impurities may be removed by periodic back-flashing of the electrode. To enhance this process, it is required that, in addition to hydrophilicity, the electrodes of this invention also possess hydrophobic properties. The balance between hydrophilicity and hydrophobicity of the electrode may be controlled, in accordance with one embodiment of this invention, by the appropriate selection of polarizable polymer and cross-linking agent. For example, poly(vinyl alcohol) (PVOH) has fewer —CH₂ groups than poly(ethylene vinyl alcohol) (PEVOH). In PEVOH, the ethylene group provides hydrophobicity. Certain cross-linking agents, such as formaldehyde, have fewer —CH₂ groups than glutaraldehyde and glyoxal. As the number of —CH₂ groups increases, hydrophobicity increases and hydrophilicity decreases. It has been found that compositions with one (1) to five (5) —CH₂ groups provide a desirable balance between hydrophilicity and hydrophobicity of the electrode. In accordance with one preferred embodiment of this invention, the electrode is provided with a hydrophobicity of up to about 50%.

In general, the electrodes of this invention may be produced by mixing metal oxide and carbon or graphite powders with a phenolic resin and a bubbler, such as ammonium bicarbonate, and molding the mixture at atmospheric pressure and elevated temperatures. The amount of ammonium bicarbonate or other bubbler employed depends on the desired porosity of the gas diffusion electrode. It has been found that a mixture comprising about 50-60 wt % graphite powders, 5-20 wt % carbon black, about 7 wt % phenolic resin and about 1-10 wt % ammonium bicarbonate molded at a temperature of about 200° C. produces a suitable electrode.

### EXAMPLE

Exfoliated graphite was produced by mixing concentrated sulfuric acid and graphite powders. The mixture was heated in an oven at 600° C. The resulting expanded graphite includes C═O and C—OH bonds on the graphite particles, which crosslink with poly(ethylene vinyl alcohol) and glutaraldehyde. The resulting graphite powders are stable in the porous plate and can not wash out during the wastewater treatment process.

### EXAMPLE

9 grams of exfoliated graphite powders were mixed with 10 grams of water and 10 grams of 10 wt % poly(vinyl alcohol), forming a first mixture. 10 grams of water were mixed with 2 grams of 40 wt % glutaraldehyde and 0.5 ml HCl (35 wt %), forming a second mixture. The two mixtures were mixed thoroughly and the resulting mixture was cast to produce a 1/16″ thick sheet which was then heat treated at 100° C. Water boiling from the plate generated bubbles, making the plate porous. Because glutaraldehyde binds with poly(vinyl alcohol) in an irreversible fashion, the resulting cross-linked polymer was entirely insoluble, even in hot water. Table 1 shows a comparison of surface resistance between the electrode produced in accordance with this example and other electrode materials.

TABLE 1
Surface Resistance Comparison

| Material | Surface Resistance (Ω) |
|---|---|
| Gold-plated copper | 0.098 |
| Dense Composite Graphite | 0.120 |
| Porous Graphite Sheet | 95 |

One application for the water purification system of this invention is marine water desalination. Electrode voltage in the range of about 0 to 1.2 V is required for desalinating the water.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A water purification system comprising:
a porous anode electrode and a porous cathode electrode, each of said electrodes comprising graphite, at least one metal oxide, and an ion-exchange, cross-linked, polarizable polymer; and
an electrically non-conductive, fluid permeable separator element disposed between said anode electrode and said cathode electrode.

2. A water purification system in accordance with claim 1, wherein said ion-exchange, cross-linked polarizable polymer is a polymer selected from the group consisting of polyurethane, polyacrylic acid, sulfonated polystyrene, poly(vinyl alcohol) and combinations thereof.

3. A water purification system in accordance with claim 1, wherein said at least one metal oxide is stable in water.

4. A water purification system in accordance with claim 3, wherein said at least one metal oxide is selected from the group consisting of TiO₂, Al₂O₃, and mixtures thereof.

5. A water purification system in accordance with claim 1, wherein said ion-exchange, cross-linked, polarizable polymer is cross-linked with a cross-linking agent selected from the group consisting of glyoxal, formaldehyde, glutaraldehyde, methylene amine, and combinations thereof.

6. A water purification system in accordance with claim 1, wherein said graphite is exfoliated graphite.

7. A water purification system in accordance with claim 6, wherein said exfoliated graphite comprises exfoliated graphite particles having a particle size less than about 50μ in diameter.

8. A water purification system in accordance with claim 1, wherein said electrodes and said separator element are disposed within an electronically non-conductive housing having a wastewater inlet opening and a pure water outlet opening.

9. A water purification system in accordance with claim 1, wherein said electrodes are substantially hydrophilic.

10. A water purification system in accordance with claim 9, wherein said electrodes comprise at least one hydrophobic group.

11. A water purification system in accordance with claim 1, wherein said electrodes comprise a substrate embedded within said electrodes.

12. A water purification system in accordance with claim 1, wherein said electrically non-conductive, fluid permeable separator element is a perforated plastic sheet having an open area of at least about 60%.

13. A water purification system in accordance with claim 1, wherein at least one of said electrodes comprises carbon black.

14. A water purification system in accordance with claim 1, wherein said porous electrodes have a porosity of at least about 50% by volume of said electrodes.

15. An electrode of a water purification system comprising:
graphite, at least one metal oxide, and an ion-exchange, cross-linked, polarizable polymer and having a porosity of at least about 50% by volume of said electrode.

16. An electrode in accordance with claim 15, wherein said ion-exchange, cross-linked, polarizable polymer is a polymer selected from the group consisting of polyurethane, polyacrylic acid, sulfonated polystyrene, poly(vinyl alcohol) and combinations thereof.

17. An electrode in accordance with claim 15, wherein said graphite is exfoliated graphite comprising exfoliated graphite particles having a particle size less than about 50μ in diameter.

18. An electrode in accordance with claim 15, wherein said ion-exchange, cross-linked, polarizable polymer is cross-linked with a cross-linking agent selected from the group consisting of glyoxal, formaldehyde, glutaraldehyde, methylene amine, and combinations thereof.

19. An electrode in accordance with claim 15, wherein a support substrate is embedded within an interior of said electrode.

20. An electrode in accordance with claim 15, said electrode being substantially hydrophilic.

21. An electrode in accordance with claim 20 comprising at least one hydrophobic group.

22. An electrode in accordance with claim 15 further comprising carbon black dispersed substantially uniformly throughout said electrode.

23. An electrode in accordance with claim 15, wherein said electrode has been treated in a phosphoric acid solution to increase corrosion resistance.

24. An electrode in accordance with claim 15, wherein said at least one metal oxide is selected from the group consisting of TiO₂, Al₂O₃ and mixtures thereof.
